(19) United States
(12) Patent Application Publication
(10) Pub. No.: US 2026/0016970 A1
(43) Pub. Date: Jan. 15, 2026

(54) Data Storage Device and Method for Using Modular Models for Inferring a Read Threshold

(71) Applicant: Sandisk Technologies, Inc., Milpitas, CA (US)

(72) Inventors: David Avraham, San Jose, CA (US); Eran Sharon, Rishon Lezion (IL); Alexander Bazarsky, Holon (IL); Ariel Navon, Revava (IL)

(73) Assignee: Sandisk Technologies, Inc., Milpitas, CA (US)

(21) Appl. No.: 18/772,563

(22) Filed: Jul. 15, 2024

(51) Int. Cl. G06F 3/06

(52) U.S. Cl. CPC G06F 3/0619; G06F 3/0656; G06F 3/0679

(57) ABSTRACT

A model can be used to infer a read threshold for reading a memory of a data storage device. In some situations, such as when the memory has an open wordline or an open block, the model may not provide an accurate read threshold. In such situations, one or more additional models can be used as modular add-ons to the original model to provide a more-accurate read threshold, which can result in a reduced bit error rate, as well as improved throughput, quality of service, and power consumption.

### BACKGROUND

One of the main challenges introduced by NAND process shrinking and three-dimensional stacking is maintaining process uniformity. In addition, data storage devices may need to support a wide range of operational conditions (such as different program/erase cycles, retention times, and temperatures), which can lead to increased variability between memory dies, blocks, and pages across the different operational conditions. Due to these variations, the read thresholds (RT) used for reading a memory page in some data storage devices are not fixed and can change significantly as a function of the physical location and the operational conditions, especially for less-mature memory nodes.

### BRIEF DESCRIPTION OF THE DRAWINGS

FIG. 1A is a block diagram of a data storage device of an embodiment.

FIG. 1B is a block diagram illustrating a storage module of an embodiment.

FIG. 1C is a block diagram illustrating a hierarchical storage system of an embodiment.

FIG. 2A is a block diagram illustrating components of the controller of the data storage device illustrated in FIG. 1A according to an embodiment.

FIG. 2B is a block diagram illustrating components of the data storage device illustrated in FIG. 1A according to an embodiment.

FIG. 3 is a block diagram of a host and a data storage device of an embodiment.

FIG. 4 is an illustration of a constant forest solution of an embodiment.

FIG. 5 is an illustration of an additive forest model for an open wordline/block corner case of an embodiment.

FIG. 6 is an illustration of an additive model with table-based add-ons for an open wordline/block corner case.

FIGS. 7A and 7B are flow charts of methods of an embodiment.

### DETAILED DESCRIPTION

The following embodiments generally relate to a data storage device and method for using modular models for inferring a read threshold. In one embodiment, a data storage device is provided comprising a memory and one or more processors. The one or more processors, individually or in combination, are configured to: determine whether a condition exists in the data storage device that triggers use of at least one add-on model as a modular addition to a base model; in response to determining that the condition does not exist: use the base model to infer a first read threshold; and read the memory using the first read threshold; and in response to determining that the condition exists: use the at least one add-on module and the base model to infer a second read threshold; and read the memory using the second read threshold.

In another embodiment, a method is provided that is performed in a data storage device comprising a memory. The method comprises: determining to use at least one add-on model in addition to a base model; inferring a read threshold using the at least one add-on model in addition to the base model; and using the read threshold to read the memory.

In yet another embodiment, a data storage device comprising: a memory; and means for: using at least one add-model in addition to a base model to infer a read threshold; and using the read threshold to read the memory.

Other embodiments are possible, and each of the embodiments can be used alone or together in combination. Accordingly, various embodiments will now be described with reference to the attached drawings.

### Embodiments

The following embodiments relate to a data storage device (DSD). As used herein, a “data storage device” refers to a non-volatile device that stores data. Examples of DSDs include, but are not limited to, hard disk drives (HDDs), solid state drives (SSDs), tape drives, hybrid drives, etc. Details of example DSDs are provided below.

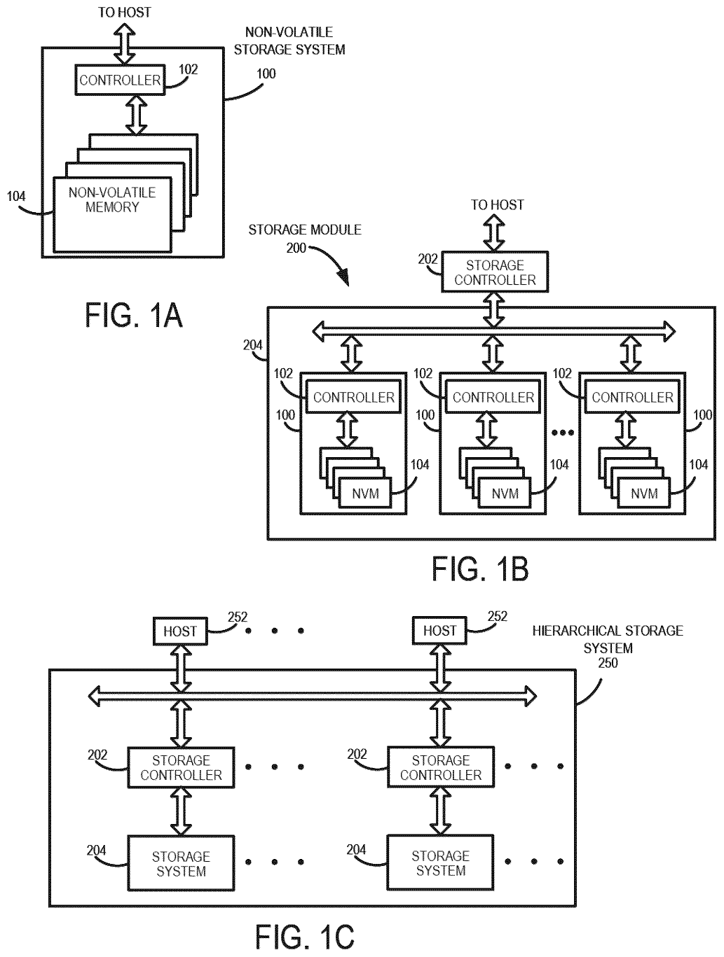

Examples of data storage devices suitable for use in implementing aspects of these embodiments are shown in FIGS. 1A-1C. It should be noted that these are merely examples and that other implementations can be used. FIG. 1A is a block diagram illustrating the data storage device 100 according to an embodiment. Referring to FIG. 1A, the data storage device 100 in this example includes a controller 102 coupled with a non-volatile memory that may be made up of one or more non-volatile memory die 104. As used herein, the term die refers to the collection of non-volatile memory cells, and associated circuitry for managing the physical operation of those non-volatile memory cells, that are formed on a single semiconductor substrate. The controller 102 interfaces with a host system and transmits command sequences for read, program, and erase operations to non-volatile memory die 104. Also, as used herein, the phrase “in communication with” or “coupled with” could mean directly in communication/coupled with or indirectly in communication/coupled with through one or more components, which may or may not be shown or described herein. The communication/coupling can be wired or wireless.

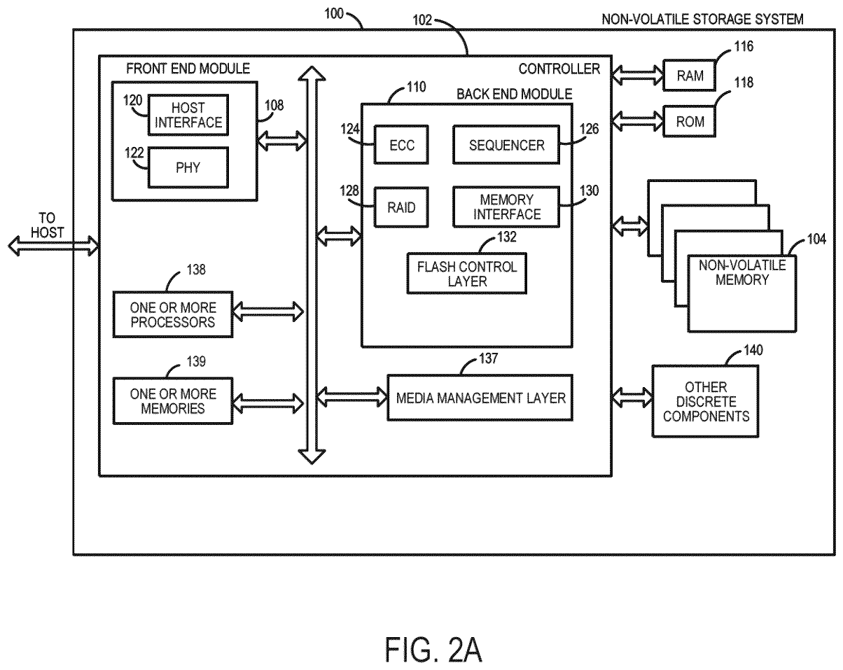

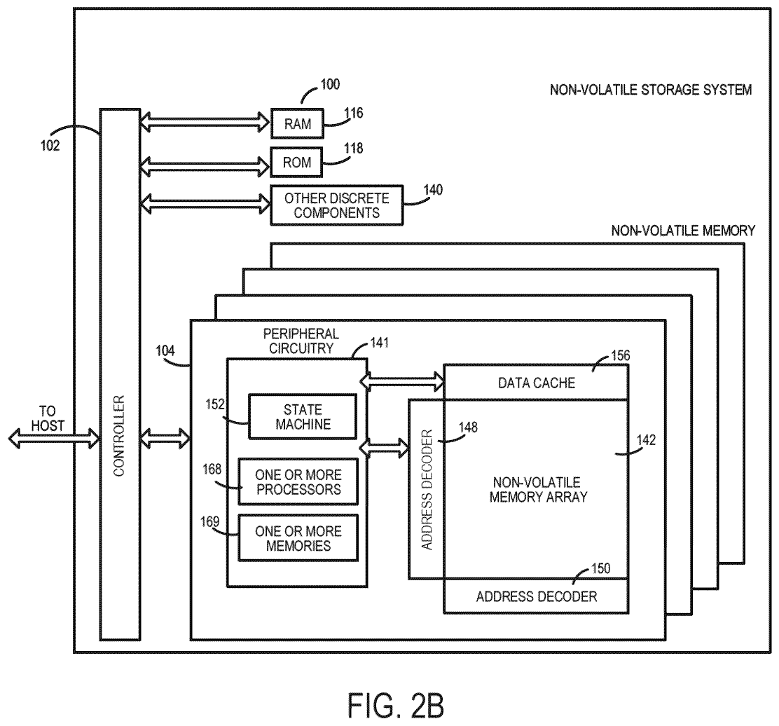

The controller 102 (which may be a non-volatile memory controller (e.g., a flash, resistive random-access memory (ReRAM), phase-change memory (PCM), or magnetoresistive random-access memory (MRAM) controller)) can include one or more components, individually or in combination, configured to perform certain functions, including, but not limited to, the functions described herein and illustrated in the flow charts. For example, as shown in FIG. 2A, the controller 102 can comprise one or more processors 138 that are, individually or in combination, configured to perform functions, such as, but not limited to the functions described herein and illustrated in the flow charts, by executing computer-readable program code stored in one or more non-transitory memories 139 inside the controller 102 and/or outside the controller 102 (e.g., in random access memory (RAM) 116 or read-only memory (ROM) 118). As another example, the one or more components can include circuitry, such as, but not limited to, logic gates, switches, an application specific integrated circuit (ASIC), a programmable logic controller, and an embedded microcontroller.

In one example embodiment, the non-volatile memory controller 102 is a device that manages data stored on non-volatile memory and communicates with a host, such as a computer or electronic device, with any suitable operating system. The non-volatile memory controller 102 can have various functionality in addition to the specific functionality described herein. For example, the non-volatile memory controller can format the non-volatile memory to ensure the memory is operating properly, map out bad non-volatile memory cells, and allocate spare cells to be substituted for future failed cells. Some part of the spare cells can be used to hold firmware (and/or other metadata used for housekeeping and tracking) to operate the non-volatile memory controller and implement other features. In operation, when a host needs to read data from or write data to the non-volatile memory, it can communicate with the non-volatile memory controller. If the host provides a logical address to which data is to be read/written, the non-volatile memory controller can convert the logical address received from the host to a physical address in the non-volatile memory. The non-volatile memory controller can also perform various memory management functions, such as, but not limited to, wear leveling (distributing writes to avoid wearing out specific blocks of memory that would otherwise be repeatedly written to) and garbage collection (after a block is full, moving only the valid pages of data to a new block, so the full block can be erased and reused).

Non-volatile memory die 104 may include any suitable non-volatile storage medium, including resistive random-access memory (ReRAM), magnetoresistive random-access memory (MRAM), phase-change memory (PCM), NAND flash memory cells and/or NOR flash memory cells. The memory cells can take the form of solid-state (e.g., flash) memory cells and can be one-time programmable, few-time programmable, or many-time programmable. The memory cells can also be single-level cells (SLC), multiple-level cells (MLC) (e.g., dual-level cells, triple-level cells (TLC), quad-level cells (QLC), etc.) or use other memory cell level technologies, now known or later developed. Also, the memory cells can be fabricated in a two-dimensional or three-dimensional fashion.

The interface between controller 102 and non-volatile memory die 104 may be any suitable flash interface, such as Toggle Mode 200, 400, or 800. In one embodiment, the data storage device 100 may be a card-based system, such as a secure digital (SD) or a micro secure digital (micro-SD) card. In an alternate embodiment, the data storage device 100 may be part of an embedded data storage device.

Although, in the example illustrated in FIG. 1A, the data storage device 100 (sometimes referred to herein as a storage module) includes a single channel between controller 102 and non-volatile memory die 104, the subject matter described herein is not limited to having a single memory channel. For example, in some architectures (such as the ones shown in FIGS. 1B and 1C), two, four, eight or more memory channels may exist between the controller and the memory device, depending on controller capabilities. In any of the embodiments described herein, more than a single channel may exist between the controller and the memory die, even if a single channel is shown in the drawings.

FIG. 1B illustrates a storage module 200 that includes plural non-volatile data storage devices 100. As such, storage module 200 may include a storage controller 202 that interfaces with a host and with data storage device 204, which includes a plurality of data storage devices 100. The interface between storage controller 202 and data storage devices 100 may be a bus interface, such as a serial advanced technology attachment (SATA), peripheral component interconnect express (PCIe) interface, double-data-rate (DDR) interface, or serial attached small scale compute interface (SAS/SCSI). Storage module 200, in one embodiment, may be a solid-state drive (SSD), or non-volatile dual in-line memory module (NVDIMM), such as found in server PC or portable computing devices, such as laptop computers, and tablet computers.

FIG. 1C is a block diagram illustrating a hierarchical storage system. A hierarchical storage system 250 includes a plurality of storage controllers 202, each of which controls a respective data storage device 204. Host systems 252 may access memories within the storage system 250 via a bus interface. In one embodiment, the bus interface may be a Non-Volatile Memory Express (NVMe) or Fibre Channel over Ethernet (FCOE) interface. In one embodiment, the system illustrated in FIG. 1C may be a rack mountable mass storage system that is accessible by multiple host computers, such as would be found in a data center or other location where mass storage is needed.

Referring again to FIG. 2A, the controller 102 in this example also includes a front-end module 108 that interfaces with a host, a back-end module 110 that interfaces with the one or more non-volatile memory die 104, and various other components or modules, such as, but not limited to, a buffer manager/bus controller module that manage buffers in RAM 116 and controls the internal bus arbitration of controller 102. A module can include one or more processors or components, as discussed above. The ROM 118 can store system boot code. Although illustrated in FIG. 2A as located separately from the controller 102, in other embodiments one or both of the RAM 116 and ROM 118 may be located within the controller 102. In yet other embodiments, portions of RAM 116 and ROM 118 may be located both within the controller 102 and outside the controller 102.

Front-end module 108 includes a host interface 120 and a physical layer interface (PHY) 122 that provide the electrical interface with the host or next level storage controller. The choice of the type of host interface 120 can depend on the type of memory being used. Examples of host interfaces 120 include, but are not limited to, SATA, SATA Express, serially attached small computer system interface (SAS), Fibre Channel, universal serial bus (USB), PCIe, and NVMe. The host interface 120 typically facilitates transfer for data, control signals, and timing signals.

Back-end module 110 includes an error correction code (ECC) engine 124 that encodes the data bytes received from the host, and decodes and error corrects the data bytes read from the non-volatile memory. A command sequencer 126 generates command sequences, such as program and erase command sequences, to be transmitted to non-volatile memory die 104. A RAID (Redundant Array of Independent Drives) module 128 manages generation of RAID parity and recovery of failed data. The RAID parity may be used as an additional level of integrity protection for the data being written into the memory device 104. In some cases, the RAID module 128 may be a part of the ECC engine 124. A memory interface 130 provides the command sequences to non-volatile memory die 104 and receives status information from non-volatile memory die 104. In one embodiment, memory interface 130 may be a double data rate (DDR) interface, such as a Toggle Mode 200, 400, or 800 interface. The controller 102 in this example also comprises a media management layer 137 and a flash control layer 132, which controls the overall operation of back-end module 110.

The data storage device 100 also includes other discrete components 140, such as external electrical interfaces, external RAM, resistors, capacitors, or other components that may interface with controller 102. In alternative embodiments, one or more of the physical layer interface 122, RAID module 128, media management layer 138 and buffer management/bus controller are optional components that are not necessary in the controller 102.

FIG. 2B is a block diagram illustrating components of non-volatile memory die 104 in more detail. Non-volatile memory die 104 includes peripheral circuitry 141 and non-volatile memory array 142. Non-volatile memory array 142 includes the non-volatile memory cells used to store data. The non-volatile memory cells may be any suitable non-volatile memory cells, including ReRAM, MRAM, PCM, NAND flash memory cells and/or NOR flash memory cells in a two-dimensional and/or three-dimensional configuration. Non-volatile memory die 104 further includes a data cache 156 that caches data and address decoders 148, 150. The peripheral circuitry 141 in this example includes a state machine 152 that provides status information to the controller 102. The peripheral circuitry 141 can also comprise one or more components that are, individually or in combination, configured to perform certain functions, including, but not limited to, the functions described herein and illustrated in the flow charts. For example, as shown in FIG. 2B, the memory die 104 can comprise one or more processors 168 that are, individually or in combination, configured to execute computer-readable program code stored in one or more non-transitory memories 169, stored in the memory array 142, or stored outside the memory die 104. As another example, the one or more components can include circuitry, such as, but not limited to, logic gates, switches, an application specific integrated circuit (ASIC), a programmable logic controller, and an embedded microcontroller.

In addition to or instead of the one or more processors 138 (or, more generally, components) in the controller 102 and the one or more processors 168 (or, more generally, components) in the memory die 104, the data storage device 100 can comprise another set of one or more processors (or, more generally, components). In general, wherever they are located and however many there are, one or more processors (or, more generally, components) in the data storage device 100 can be, individually or in combination, configured to perform various functions, including, but not limited to, the functions described herein and illustrated in the flow charts. For example, the one or more processors (or components) can be in the controller 102, memory device 104, and/or other location in the data storage device 100. Also, different functions can be performed using different processors (or components) or combinations of processors (or components). Further, means for performing a function can be implemented with a controller comprising one or more components (e.g., processors or the other components described above).

Returning again to FIG. 2A, the flash control layer 132 (which will be referred to herein as the flash translation layer (FTL) handles flash errors and interfaces with the host. In particular, the FTL, which may be an algorithm in firmware, is responsible for the internals of memory management and translates writes from the host into writes to the memory 104. The FTL may be needed because the memory 104 may have limited endurance, may be written in only multiples of pages, and/or may not be written unless it is erased as a block. The FTL understands these potential limitations of the memory 104, which may not be visible to the host. Accordingly, the FTL attempts to translate the writes from host into writes into the memory 104.

The FTL may include a logical-to-physical address (L2P) map (sometimes referred to herein as a table or data structure) and allotted cache memory. In this way, the FTL translates logical block addresses (“LBAs”) from the host to physical addresses in the memory 104. The FTL can include other features, such as, but not limited to, power-off recovery (so that the data structures of the FTL can be recovered in the event of a sudden power loss) and wear leveling (so that the wear across memory blocks is even to prevent certain blocks from excessive wear, which would result in a greater chance of failure).

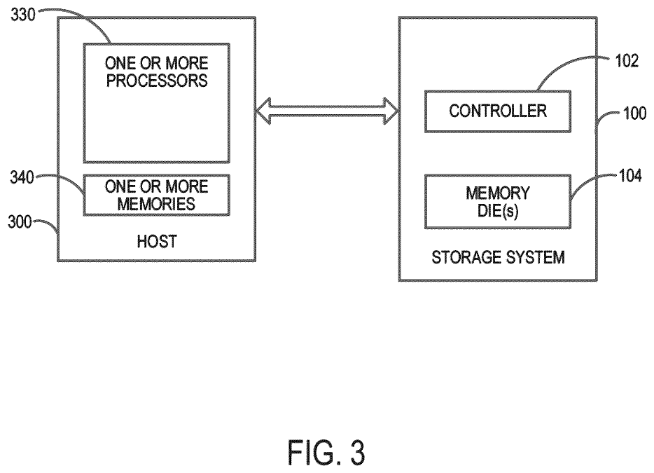

Turning again to the drawings, FIG. 3 is a block diagram of a host 300 and data storage device 100 of an embodiment. The host 300 can take any suitable form, including, but not limited to, a computer, a mobile phone, a tablet, a wearable device, a digital video recorder, a surveillance system, etc. The host 300 in this embodiment (here, a computing device) comprises one or more processors 330 and one or more memories 340. In one embodiment, computer-readable program code stored in the one or more memories 340 configures the one or more processors 330 to perform the acts described herein as being performed by the host 300. So, actions performed by the host 300 are sometimes referred to herein as being performed by an application (computer-readable program code) run on the host 300. For example, the host 300 can be configured to send data (e.g., initially stored in the host's memory 340) to the data storage device 100 for storage in the data storage device's memory 104.

As mentioned above, one of the main challenges introduced by NAND process shrinking and three-dimensional stacking is maintaining process uniformity. In addition, data storage devices may need to support a wide range of operational conditions (such as different program/erase cycles, retention times, and temperatures), which can lead to increased variability between memory dies, blocks, and pages across the different operational conditions. Due to these variations, the read thresholds (RT) used for reading a memory page in some data storage devices are not fixed and can change significantly as a function of the physical location and the operational conditions, especially for less-mature new memory nodes.

Reading with an inaccurate read threshold can lead to a higher bit error rate (BER), which can degrade performance and quality of service (QOS) due to decoding failures, which can require invoking high-latency recovery flows that can cause delays and hiccups in performance. The challenge of maintaining an optimal read threshold can be especially important for enterprise memory systems for which the quality-of-service requirements are very strict and for mobile, internet of things (IoT), and automotive memory systems for which the required range of operational conditions is wide and the frequency of condition changes (e.g., temperature) may be high. The problem is even more difficult during transitions to new, less-mature memory nodes.

Current solutions for read threshold calibration, such as BER estimation scan (BES) and valley search (VS), are high-latency operations aimed at optimizing read thresholds for a specific wordline, which is good for rare read recovery flows in cases of failure to decode the data but may not be suitable for frequent operations in case of frequent read threshold changes. Hence, in order to cope with this issue, Flash memory systems can implement read threshold management schemes that try to track read threshold changes in the background via a maintenance process to ensure that appropriate read thresholds are used when the host issues a read command.

One approach is to track the read threshold per group of blocks that share the same conditions. More specifically, blocks that are written roughly at the same time and temperature are grouped into time and temperature (TT) groups. Read thresholds are tracked for each time-and-temperature group, usually acquired on some representative wordline from a block within the group. When the host performs a read operation, the read threshold associated with the time-and-temperature group corresponding to the read block are used, where additional adaptation to the read threshold, according to the specific read wordline, is performed based on pre-calibrated wordline zoning tables.

Some read threshold management schemes may not adequately track the read threshold under frequently-changing conditions and high variations between memory pages. Various solutions to address that issue are possible. For example, U.S. patent application Ser. No. 17/838,481, filed Jun. 13, 2022, which is hereby incorporated by reference, describes a read threshold calibration method that applies a machine learning (ML) prediction model, including specifically a system and method for inferring an optimal read threshold from various available information, including time-and-temperature group information, temperature information, bit error rate (BER) information, program-erase count (PEC) information, and physical page location.

As another example, U.S. patent application Ser. No. 17/899,073, filed Aug. 30, 2022; Ser. No. 18/220,363, filed Jul. 11, 2023; and Ser. No. 18/242,061, filed Sep. 5, 2023, which are hereby incorporated by reference, describe a method that allows for implementation of an inference engine for faster and more-accurate acquisition of read thresholds. In one embodiment described there, a binary tree model is used to efficiently store only a subset of relevant correction data. In addition, it does not need to directly read from the memory to perform threshold calibrations; hence, it is much faster than BES/VS-based calibrations. The unique structure of the binary tree allows for a fast and low area and power solution.

Additionally, U.S. patent application Ser. No. 18/658,074, filed May 8, 2024, which is hereby incorporated by reference, describes a hardware implementation. A hardware implementation can impose strict limitations on the complexity of the implemented prediction model. Accordingly, an efficient prediction-model-based collection of symmetric trees can be used, as described in the patent applications references above. However, although a symmetric prediction trees model may be capable of describing complex non-linear functions of the input features, it can have an inherent downside of being discreet (non-continuous). This property of random-forest models can limit prediction accuracy as it has only a finite number of potential output values. The impact of this limitation on model performance can increase as the hardware requirements become more strict.

As described above, read threshold selection can be a complicated task that may be highly suitable for machine learning techniques. As such, an artificial intelligence-based read threshold (ART) mode can be used to replace legacy read thresholds schemes. One implementation of ART is a multi-model inference engine that is capable of inferring from several different types of models in real-time with high accuracy and minimal latency. Other partial implementations can include firmware derivatives of this approach.

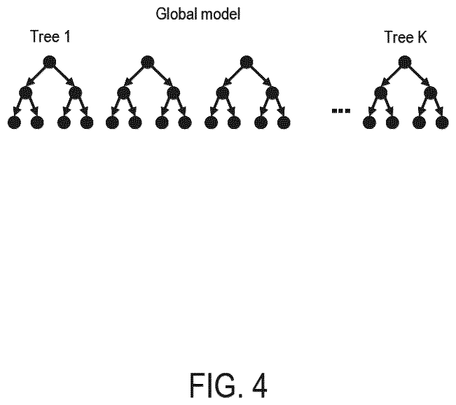

In one of the applications referenced above, a new concept of read threshold calibration was presented by applying a machine learning (ML) prediction model, including specifically a system and method for inferring an optimal read threshold from all available information, including time-and-temperature group information, temperature information, bit error rate (BER) information, program-erase count (PEC) information, and physical page location. FIG. 4 is an illustration of a constant forest solution of an embodiment, which is sometimes referred to below as the base model. More specifically, FIG. 4 depicts a full homogenous model of K trees where all trees are used for inference regardless of the used features or conditions. One of the applications referenced above described an implementation of an inference engine for faster and more-accurate acquisition of read thresholds. This method uses a binary tree model to efficiently store only a subset of relevant correction data. In addition, it does not need to directly read from the non-volatile memory to perform threshold calibrations; hence, it can operate much faster than BES/VS-based calibrations. The unique structure of the binary tree allows for a fast and low area power solution.

A good machine learning model may need to cover various data storage device conditions and condition stacking, hence may need to cover many corner cases. For example, open blocks and specifically open wordlines (e.g., the latest wordline written to a block) have unique physical properties that differentiate them from closed blocks and induce very different optimal read thresholds. However, open blocks and specifically open wordlines can be very rare. This can pose a problem in a machine learning solution, as it can make data collection very difficult due to a limited sample set size, where data collection is usually a major challenge in such cases. In turn, this rare data impact on the model can be small. Indeed, this limitation can principally be mitigated by oversampling or using higher weights for such samples, but that will only solve the impact on the model output and will not solve the coverage problem.

It would be beneficial to allow a modular design that holds a main model for the common use cases but also has special treatment for interesting corner cases as well as important rare events. It can be ensured that the handling of such cases does not call for complicated special treatment or flows. Some prior solutions are based on one large model under the assumption that the model will have good coverage of the data, that the data space is easy to sample, and that corner cases will get a different treatment (e.g., a special firmware flow to handle such case).

The following embodiments can be used to address the relatively-rare problem of open blocks and open wordlines using simple hardware for all input feature combinations, handling both common data and corner cases with high accuracy. More specifically, one embodiment provides a modular-model system for a flexible read-threshold prediction. Such a modular design can be composed of a basic (base) model that covers the typical conditions and, in addition, contains add-on models that cover specific conditions. Such specific conditions are, for example, open wordlines, open blocks, or any other corner cases that can be predefined and which are too rare to be covered by the common model. Each add-on model can be specifically trained or calibrated to cover a specific use case or group of use cases.

In one example implementation, the controller 102 of the data storage device 100 uses (a) a basic common model to cover typical conditions and infer read thresholds and (b) one or more add-on models on top of the common model to cover corner cases and difficult conditions. The add-on models can take the form, for example, of offline-characterized tables that are saved in advance in the data storage device 100 (e.g., in a dedicated internal memory (e.g., RAM)) or loaded online on demand from the memory 104 in the data storage device 100, from a host memory buffer (HMB) in the host 300, or from another location.

As discussed above, the ART model is a tree-based model designed to capture all system features and use them to infer the optimal read threshold. Input features can include one or more of the following: addressing, temperature data, data retention (DR) data, program-erase count (PEC), bit error rate (BER) measurements, BER estimates or proxies such as ECC Syndrome Weight (SW), previous read thresholds, samples or estimations of read thresholds in offline calibrated state tables, wordline number, plane number, string number, logical page number, etc. This model has a simple hardware implementation that allows for a low latency paralleled and piped inference that traverses many trees and efficiently adds their correction terms. This implementation can infer results of a single model of up to K trees, where K is a predefined parameter. As will be discussed more below, by using its additive behavior, this implementation be used to provide a modular model with a common model and add-on models.

In one embodiment directed to model-based add-ons, in order to mitigate corner cases or rare cases for which data collection is difficult or data is rare, a machine learning (ML) model may be divided into two or more models, where a common model is trained on all the available common data to yield optimal results for these cases, and an addition model or models are trained on specific corner cases using the available data. The additional models are used as an add-on to the base model in case the input features or other metadata indicates such a corner case is at hand. In this specific ART implementation, the common model and add-ons are forest-based models (e.g. gradient boosting, bagging, etc.); however, other suitable types of models can be used.

An additive topology can have one or more of the following properties: the common model can have one or more trees, there may be one or more add-on model, each add-on model can be a forest comprised of one or more trees, a specific corner case can use the common model and one or more add-on models, and the use of an additional model can be triggered by a certain indication (e.g., an open wordline, an open block, a read/write temperature above a threshold, a program-erase count (PEC) above a threshold, a specific system state status (e.g., recovery from a power cycle), a specific data address, etc.).

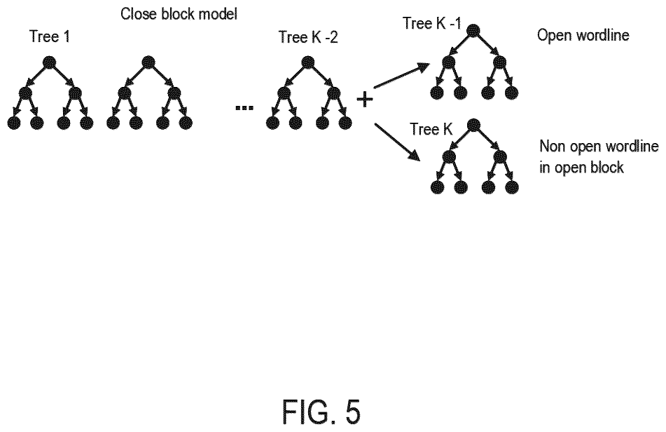

FIG. 5 is an illustration of an additive forest model for an open wordline/block corner case of an embodiment. This figure depicts an additive model with a maximum size of K trees where some of the trees are used for inference for the common case and other may be used as add-ons. In this example, out of the K trees supported by the system, K-minus-2 trees are used as a common forest model trained on closed blocks data. Tree K-minus-1 is used as a forest of one tree that is dedicated to correct read thresholds on open wordlines, and Tree K is used as a forest of one tree that is dedicated to correct read thresholds on non-open wordlines in an open block. As these two cases are mutually exclusive in this example, there are three modes of operation: (1) common model, (2) common model+open wordline model, and (3) common model+non-open wordlines in an open block model.

Turning now to an embodiment regarding table-based add-ons, in order to mitigate corner cases or rare cases for which data collection is difficult or data is rare, the machine learning model can be divided into two or more parts. The first part can be a common model that is trained on all the available and common data, yielding optimal results for these cases, and an addition model or models can be trained on specific corner cases using the available data. The additional part or parts are used as an add-on to the base model in case the input features or other metadata indicates such a corner case is at hand.

In this specific ART implementation, the common model is forest-based (e.g. gradient boosting, bagging, etc.), and the add-ons are table-based data. As explained above, traversing the tree is equivalent to building an index to a lookup table, and the values are read from a large memory according to that index. Therefore, by changing the logic that generates the index or by creating the index externally either statically or dynamically, the same memory can also be accessed directly, hence working as a table. As such, each table can replace one or more trees of the basic model. The tables, by their nature, are smaller and denser. Thus, they are limited in coverage but can be trained using smaller amounts of data to fully cover a corner case.

A table-based additive topology may have one or more of the following properties: the common model can have one or more trees, there can be one or more add-on tables, each add-on table can be of a different size and use different logic for indexing, indices can be based on one or more of the input features, a specific corner case can use the common model and one or more add-on tables, and an indication for use of an additional table may be based on certain condition(s) (e.g., an open wordline, an open block, read/write temperature above a threshold, PEC above a threshold, a certain system state status (e.g. recovery from a power cycle), a specific data addresses, etc.)

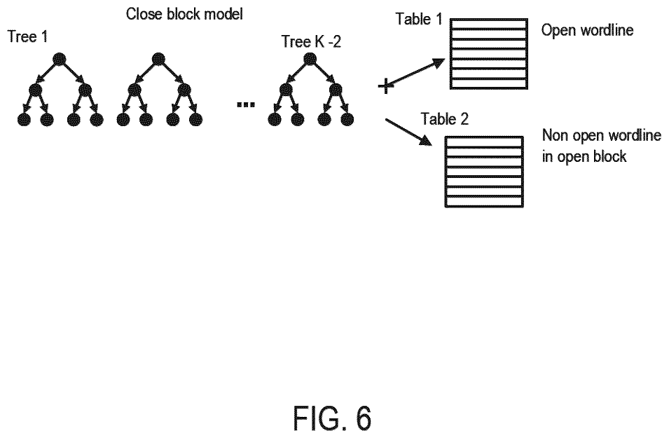

FIG. 6 is an illustration of an additive model with table-based add-ons for an open wordline/block corner case. In this example implementation, out of the K trees supported by the system, K-2 trees are used as a common forest model trained on closed blocks data. Table 1 is used instead of one tree and is dedicated to correct read thresholds on open wordlines, and Table 2 is used instead of one tree and is dedicated to correct read thresholds on non-open wordlines in an open block. As these two cases are mutually exclusive in this example, there are three modes of operation: (1) common model, (2) common model+open wordline table, and (3) common model+non-open wordlines in an open block table

Another embodiment relates to a relatively-simple hardware/firmware implementation. During inference, the values of all trees are added up, and a hardware/firmware-based solution can be agnostic to the underlying meaning of each additional add-on and may treat the full range as one large forest. This operation mode can require an indication of which of the trees to add to the final sum (or which of the trees to calculate). Hence, the implementation of a modular model may reuse the implementation of the typical model with the addition of an indication method. For example, if the model holds K trees, in the common use case, it can be indicated to add the results of trees 1 to 58. In the case of an open wordline, it can be indicated to add trees 1 to 59. In the case of a non-open wordline of an open block, it can be indicted to add trees 1 to 58 and 60.

In yet another embodiment, models can be trained to take in to account the predictions of previous models, such that the results are complementary. Hence, each model can take in to account the corrections made by its previous models, which is the case where the behavior is coupled. Alternatively, the models or tables can be trained under the assumption that the correction terms are independent. Hence, a purely additive manner can be used, and each of the parts can be trained or calibrated independently.

In other use cases, the additive models can be trained using pre-calibrated tables. Some aspects of the NAND behavior can be measured for other uses; namely, for the open wordline/open block cases. Thus, instead of training the corner cases on hard-to-collect data that includes all other features, specific trees or forests can be trained to learn these measurements.

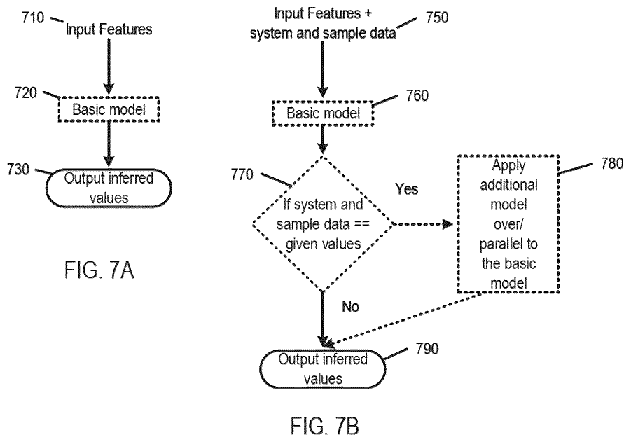

Turning again to the drawings, FIGS. 7A and 7B are flow charts of methods of an embodiment. In the method shown in FIG. 7A, input features (710) are provided to a basic model (720), which outputs inferred read threshold values (730). In the method shown in FIG. 7B, input features plus system and sample data (750) are provided to a basic model (760). The controller 102 then determines if the system and sample data satisfy a condition (770). If they do, the controller 102 applies an additional model over/parallel to the basic model (780). Otherwise the controller 102 outputs inferred read threshold values (790).

There are several advantages associated with these embodiments. For example, using dedicated prediction models to cover corner cases can provide improved thresholds, which can produce a reduced bit error rate without enlarging the hardware, cost, and computation resources (e.g., firmware overhead). Also, better read thresholds can translate to improved throughput, quality of service (QOS), and power consumption (e.g. due to shorter decoding durations), which can be important to the operation of the data storage device and to meeting end user requirements.

Finally, as mentioned above, any suitable type of memory can be used. Semiconductor memory devices include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and magnetoresistive random access memory (“MRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are examples, and memory elements may be otherwise configured.

The semiconductor memory elements located within and/or over a substrate may be arranged in two or three dimensions, such as a two-dimensional memory structure or a three-dimensional memory structure.

In a two-dimensional memory structure, the semiconductor memory elements are arranged in a single plane or a single memory device level. Typically, in a two-dimensional memory structure, memory elements are arranged in a plane (e.g., in an x-z direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and wordlines.

A three-dimensional memory array is arranged so that memory elements occupy multiple planes or multiple memory device levels, thereby forming a structure in three dimensions (i.e., in the x, y and z directions, where the y direction is substantially perpendicular and the x and z directions are substantially parallel to the major surface of the substrate).

As a non-limiting example, a three-dimensional memory structure may be vertically arranged as a stack of multiple two-dimensional memory device levels. As another non-limiting example, a three-dimensional memory array may be arranged as multiple vertical columns (e.g., columns extending substantially perpendicular to the major surface of the substrate, i.e., in the y direction) with each column having multiple memory elements in each column. The columns may be arranged in a two-dimensional configuration, e.g., in an x-z plane, resulting in a three-dimensional arrangement of memory elements with elements on multiple vertically stacked memory planes. Other configurations of memory elements in three dimensions can also constitute a three-dimensional memory array.

By way of non-limiting example, in a three-dimensional NAND memory array, the memory elements may be coupled together to form a NAND string within a single horizontal (e.g., x-z) memory device levels. Alternatively, the memory elements may be coupled together to form a vertical NAND string that traverses across multiple horizontal memory device levels. Other three-dimensional configurations can be envisioned wherein some NAND strings contain memory elements in a single memory level while other strings contain memory elements which span through multiple memory levels. Three-dimensional memory arrays may also be designed in a NOR configuration and in a ReRAM configuration.

Typically, in a monolithic three-dimensional memory array, one or more memory device levels are formed above a single substrate. Optionally, the monolithic three-dimensional memory array may also have one or more memory layers at least partially within the single substrate. As a non-limiting example, the substrate may include a semiconductor such as silicon. In a monolithic three-dimensional array, the layers constituting each memory device level of the array are typically formed on the layers of the underlying memory device levels of the array. However, layers of adjacent memory device levels of a monolithic three-dimensional memory array may be shared or have intervening layers between memory device levels.

Then again, two dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three-dimensional memory arrays. Further, multiple two-dimensional memory arrays or three-dimensional memory arrays (monolithic or non-monolithic) may be formed on separate chips and then packaged together to form a stacked-chip memory device.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements.

One of skill in the art will recognize that this invention is not limited to the two dimensional and three-dimensional structures described but cover all relevant memory structures within the spirit and scope of the invention as described herein and as understood by one of skill in the art.

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the embodiments described herein can be used alone or in combination with one another.

What is claimed is:

1. A data storage device comprising:
a memory; and
one or more processors, individually or in combination, configured to:
determine whether a condition exists in the data storage device that triggers use of at least one add-on model as a modular addition to a base model;
in response to determining that the condition does not exist:
use the base model to infer a first read threshold; and
read the memory using the first read threshold; and
in response to determining that the condition exists:
use the at least one add-on module and the base model to infer a second read threshold; and
read the memory using the second read threshold.

2. The data storage device of claim 1, wherein the condition comprises an open wordline.

3. The data storage device of claim 1, wherein the condition comprises an open block.

4. The data storage device of claim 1, wherein the condition comprises a read/write temperature above a threshold.

5. The data storage device of claim 1, wherein the condition comprises a program-erase count (PEC) above a threshold.

6. The data storage device of claim 1, wherein the condition comprises a specific system state status.

7. The data storage device of claim 1, wherein two of the at least one add-on modules are mutually exclusive.

8. The data storage device of claim 1, wherein the base model comprises a subset of trees in a forest-based model and the at least one add-on model comprise a remaining subset of trees in the forest-based model.

9. The data storage device of claim 1, wherein the at least one add-on model comprises at least one table.

10. The data storage device of claim 1, wherein the at least one add-on model is trained on predictions of previous models.

11. The data storage device of claim 1, wherein the at least one add-on model is trained independently.

12. The data storage device of claim 1, wherein input features of the base model comprise one or more of: addressing, temperature data, data retention (DR) data, program-erase count (PEC), bit error rate (BER) measurements, BER estimates or proxies such as ECC Syndrome Weight (SW), previous read thresholds, samples or estimations of read thresholds in offline calibrated state tables, wordline number, plane number, string number, and logical page number.

13. The data storage device of claim 1, wherein the memory comprises a three-dimensional memory.

14. In a data storage device comprising a memory, a method comprising:
determining to use at least one add-on model in addition to a base model;
inferring a read threshold using the at least one add-on model in addition to the base model; and
using the read threshold to read the memory.

15. The method of claim 14, wherein an open wordline triggers use of the at least one add-on model.

16. The method of claim 14, wherein an open block triggers use of the at least one add-on model.

17. The method of claim 14, wherein the at least one add-on model is stored in the data storage device.

18. The method of claim 14, wherein the at least one add-on model is stored in a host memory buffer in a host.

19. The method of claim 14, wherein the at least one add-on model and the base model comprise forest-based models.

20. A data storage device comprising:
a memory; and
means for:
using at least one add-model in addition to a base model to infer a read threshold; and
using the read threshold to read the memory.
